(19) United States
(12) Patent Application Publication
(10) Pub. No.: US 2011/0191699 A1
(43) Pub. Date: Aug. 4, 2011

(54) SYSTEM AND METHOD OF INTERFACING INTERACTIVE CONTENT ITEMS AND SHARED DATA VARIABLES

(75) Inventors: BOB CUNNINGHAM, Pittsburgh, PA (US); Greg Brown, Pittsburgh, PA (US); Mike Salandro, Pittsburgh, PA (US)

(73) Assignee: DYNAVOX SYSTEMS, LLC, PITTSBURGH, PA (US)

(21) Appl. No.: 12/698,204

(22) Filed: Feb. 2, 2010

(51) Int. Cl. G06F 3/048; G06F 3/00

(52) U.S. Cl. 715/762; 715/764

(57) ABSTRACT

Systems and methods for interfacing interactive content items and shared data variables include electronically generating a first program interface to provide a module for creating one or more interactive content items (e.g., new graphical user interfaces or other activities). A second program interface is also electronically generated to provide a module for creating one or more shared data variables (e.g., data tables or the like) and for entering data into such shared data variables. Features are also provided to generate a third program interface for defining instructions to reference one or more shared data variables from an interactive content item. The instructions created using the third program interface are electronically executed to populate one or more elements in the interactive content item with data from one or more of the shared data variables.

### CROSS-REFERENCE TO RELATED APPLICATIONS

N/A

### STATEMENT REGARDING FEDERALLY SPONSORED RESEARCH OR DEVELOPMENT

N/A

### BACKGROUND

The presently disclosed technology generally pertains to systems and methods for implementing a computer-based instructional content authoring application, and more particularly concerns systems and methods by which data tables or other variables can be interfaced to and shared among created interactive content items.

Many software-based reading and/or writing instructional applications provide features for creating a variety of interactive content items (i.e., “boards”), which may correspond, for example, to such items as printed communication boards, interactive graphical user interfaces, and other materials. Printed materials can be created with customizable combinations of pictures, graphics, text, symbols and other visual elements. Some of such elements may be linked to automated actions, such as voice, sound, animation and video to create truly interactive interfaces. Such instructional content items can be particularly useful for user communication and educational applications, particularly for special educators, speech-language pathologists, students, parents and caregivers. One example of a desktop publishing software used for the creation of such instructional content items corresponds to BOARDMAKER® software offered by DynaVox Mayer-Johnson of Pittsburgh, Pa.

Instructional software authoring tools have become useful not only for the generation of printed educational and communication materials and desktop computer interfaces, but also for integration with electronic devices that facilitate user communication and instruction. For example, electronic devices such as speech generation devices (SGDs) or Alternative and Augmentative Communication (AAC) devices can include a variety of features to assist with a user's communication.

Such devices are becoming increasingly advantageous for use by people suffering from various debilitating physical conditions, whether resulting from disease or injuries that may prevent or inhibit an afflicted person from audibly communicating. For example, many individuals may experience speech and learning challenges as a result of pre-existing or developed conditions such as autism, ALS, cerebral palsy, stroke, brain injury and others. In addition, accidents or injuries suffered during armed combat, whether by domestic police officers or by soldiers engaged in battle zones in foreign theaters, are swelling the population of potential users. Persons lacking the ability to communicate audibly can compensate for this deficiency by the use of speech generation devices.

In general, a speech generation device may include an electronic interface with specialized software configured to permit the creation and manipulation of digital messages that can be translated into audio speech output. The messages and other communication generated, analyzed and/or relayed via an SGD or AAC device may include symbols or text alone or in some combination. In one example, messages may be composed by a user by selection of buttons, each button corresponding to a graphical user interface element composed of some combination of text and/or graphics to identify the text or language element for selection by a user.

In order to better facilitate the creation of interactive content items, particularly including customized graphical interface features for use in SGD or AAC devices, as well as in other symbol-assisted reading and/or writing instructional applications, the automated creation and adaptation of such elements can be further improved. In light of the various uses of instructional authoring tools, a need continues to exist for refinements and improvements to address such concerns. While various implementations of instructional authoring applications and associated features have been developed, no design has emerged that is known to generally encompass all of the desired characteristics hereafter presented in accordance with aspects of the subject technology.

### BRIEF SUMMARY

In general, the present subject matter is directed to various exemplary speech generation devices (SGD) or other electronic devices having improved configurations for providing selected AAC features and functions to a user. More specifically, the present subject matter provides improved features and steps for interfacing interactive content items and shared data variables.

In one exemplary embodiment, a method of interfacing interactive content items and shared data variables includes electronically generating a first program interface to provide a module for creating one or more interactive content items (e.g., new graphical user interfaces of other activities). A second program interface is also electronically generated to provide a module for creating one or more shared data variables (e.g., data tables or the like) and for entering data into such shared data variables. Features are also provided to generate a third program interface for defining instructions to reference one or more shared data variables from an interactive content item. The instructions created using the third program interface are electronically executed to populate one or more elements in the interactive content item with data from one or more of the shared data variables.

It should be appreciated that still further exemplary embodiments of the subject technology concern hardware and software features of an electronic device configured to perform various steps as outlined above. For example, one exemplary embodiment concerns a computer readable medium embodying computer readable and executable instructions configured to control a processing device to implement the various steps described above or other combinations of steps as described herein.

In a still further example, another embodiment of the disclosed technology concerns an electronic device, such as but not limited to a speech generation device, including such hardware components as a processing device, at least one input device and at least one output device. The at least one input device may be adapted to receive electronic input from a user regarding the structure and definition of an interactive content item as well as the structure and data within a shared data variable and desired levels of interaction between such modules. Such user input may be provided through the one or more program interfaces provided in accordance with the subject technology. The processing device may include one or more memory elements, at least one of which stores computer executable instructions for execution by the processing device to act on the data stored in memory. The instructions adapt the processing device to function as a special purpose machine that electronically analyzes the received user input and ultimately executes instructions to populate one or more data elements within the interactive content item with data from the one or more shared data variables.

Additional aspects and advantages of the disclosed technology will be set forth in part in the description that follows, and in part will be obvious from the description, or may be learned by practice of the technology. The various aspects and advantages of the present technology may be realized and attained by means of the instrumentalities and combinations particularly pointed out in the present application.

### BRIEF DESCRIPTION OF THE DRAWINGS

The accompanying drawings, which are incorporated in and constitute a part of this specification, illustrate one or more embodiments of the presently disclosed subject matter. These drawings, together with the description, serve to explain the principles of the disclosed technology but by no means are intended to be exhaustive of all of the possible manifestations of the present technology.

FIG. 1 provides a flow chart of exemplary steps in a method of interfacing interactive content items and shared data variables;

FIG. 2 provides a first exemplary embodiment of a first graphical user interface associated with an interactive content item creation module in accordance with aspects of the present technology;

FIG. 3 provides another portion of a first exemplary embodiment of a first graphical user interface associated with an interactive content item creation module in accordance with aspects of the present technology;

FIG. 4 provides a second exemplary embodiment of a first graphical user interface associated with an interactive content item creation module in accordance with aspects of the present technology;

FIG. 5 provides a first example of an interactive content item created with an interactive content item creation module in accordance with aspects of the present technology;

FIG. 6 provides a second example of an interactive content item created with an interactive content item creation module in accordance with aspects of the present technology;

FIG. 7 provides an exemplary second graphical user interface associated with a shared data variable module in accordance with aspects of the present technology;

FIG. 8 provides an exemplary third graphical user interface associated with an interface module in accordance with aspects of the present technology;

FIG. 9 provides an exemplary view of the interactive content item of FIG. 6 after the execution of the instructions provided in FIG. 8 to populate certain items within the interactive content item with data from the shared data variable of FIG. 7; and

FIG. 10 provides a schematic view of exemplary hardware components for use with an electronic device having interactive content creation and related features in accordance with the disclosed technology.

### DETAILED DESCRIPTION OF THE PREFERRED EMBODIMENTS

Reference now will be made in detail to the presently preferred embodiments of the disclosed technology, one or more examples of which are illustrated in the accompanying drawings. Each example is provided by way of explanation of the technology, which is not restricted to the specifics of the examples. In fact, it will be apparent to those skilled in the art that various modifications and variations can be made in the present subject matter without departing from the scope or spirit thereof. For instance, features illustrated or described as part of one embodiment, can be used on another embodiment to yield a still further embodiment. Thus, it is intended that the presently disclosed technology cover such modifications and variations as may be practiced by one of ordinary skill in the art after evaluating the present disclosure. The same numerals are assigned to the same or similar components throughout the drawings and description.

The technology discussed herein makes reference to processors, servers, memories, databases, software applications, and/or other computer-based systems, as well as actions taken and information sent to and from such systems. The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein also may be implemented by hard-wired logic or other circuitry, including, but not limited to application-specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods. As noted above, such devices may access one or more computer-readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

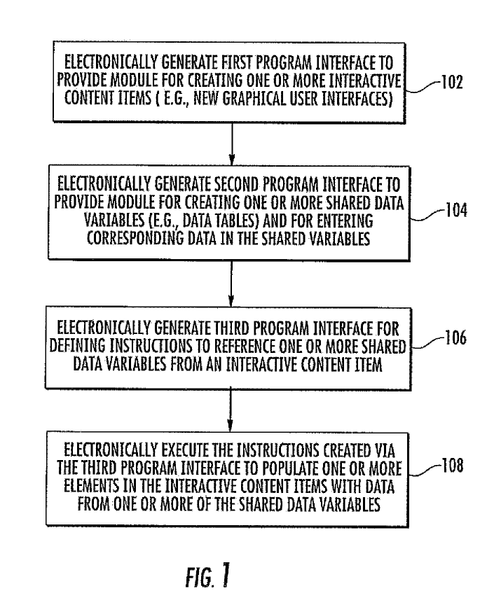

Referring now to the drawings, FIG. 1 provides a flow chart representation of an exemplary method of interfacing interactive content items (e.g., graphical user interfaces) with shared data variables (e.g., data tables). The provision of such elements and their ability to interface with one another allows for the use of coordinated interfaces in a single application to be used in the presentation of instructional material covering multiple topic areas. Various features of the presently disclosed technology provide a consistent user interface for multiple interactive content items, thus facilitating new instructional material for an already deployed application.

The steps provided in FIG. 1 and other figures herein may be performed in the order shown in such figure or may be modified in part, for example to exclude optional or non-optional steps or to perform steps in a different order than shown in FIG. 1. In particular, steps 102, 104 and 106 can all be implemented in a different order than shown in FIG. 1 before implementation of step 108.

The steps shown in FIG. 1 are part of an electronically-implemented computer-based algorithm. Computerized processing of electronic data in a manner as set forth in FIG. 1 may be performed by a special-purpose machine corresponding to some computer processing device configured to implement such algorithm. Additional details regarding the hardware provided for implementing such computer-based algorithm are provided in FIG. 10.

The graphical user interfaces or other interactive content items created in accordance with the presently disclosed technology correspond to respective visual transformations of computer instructions that have been executed by a processor associated with a device. Visual output corresponding to a graphical user interface, including text, symbols, icons, menus, templates, so-called “buttons” or other features may be displayed on an output device associated with an electronic device such as an AAC device or mobile device.

Buttons or other features can provide a user interface element by which a user can select additional interface options or language elements. Such user interface features then may be selectable by a user (e.g., via an input device, such as a mouse, keyboard, touchscreen, eye gaze controller, virtual keypad or the like). When selected, the user input features can trigger control signals that can be relayed to the central computing device within an electronic device to perform an action in accordance with the selection of the user buttons. Such additional actions may result in execution of additional instructions, display of new or different user interface elements, or other actions as desired. As such, user interface elements also may be viewed as display objects, which are graphical representations of system objects that are selectable by a user. Some examples of system objects include device functions, applications, windows, files, alerts, events or other identifiable system objects.

One device function that may be triggered by selection of a user interface element corresponds to a language function whereby words, phrases, sounds or recordings are “spoken” as audio output for a user. For example, speaking a word or phrase may consist of playing a recorded message or sound or speaking text using a voice synthesizer. In accordance with such functionality, some user interfaces are provided with a “Message Window” in which a user provides text, symbols corresponding to text, and/or related or additional information which then may be interpreted by a text-to-speech engine and provided as audio output via device speakers. Speech output may be generated in accordance with one or more preconfigured text-to-speech generation tools in male or female and adult or child voices, such as but not limited to such products as offered for sale by Cepstral, HQ Voices offered by Acapela, Flexvoice offered by Mindmaker, DECtalk offered by Fonix, Loquendo products, VoiceText offered by NeoSpeech, products by AT&T's Natural Voices offered by Wizzard, Microsoft Voices, digitized voice (digitally recorded voice clips) or others.

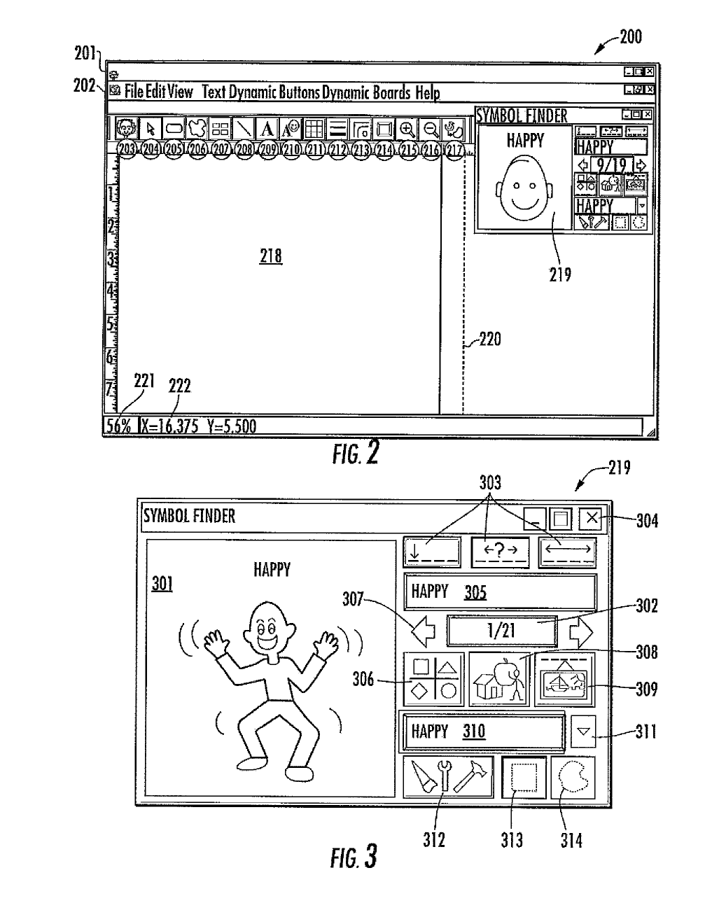

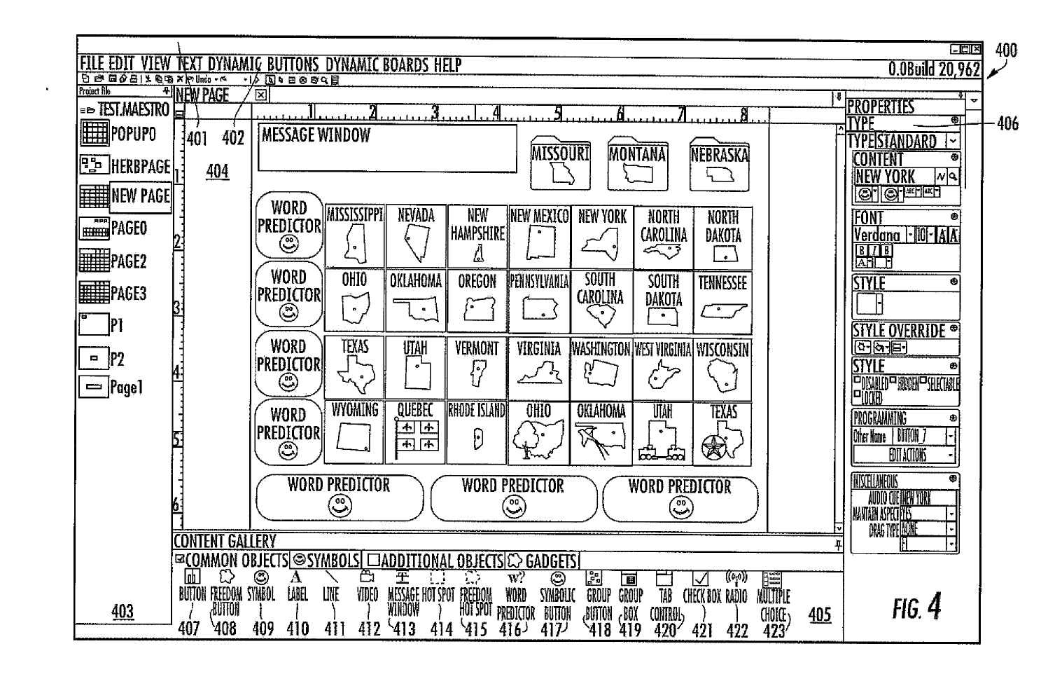

A first exemplary step 102 in the method of FIG. 1 is to electronically generate a first program interface to provide a module for creating one or more interactive content items. One example of an interactive content item corresponds to a graphical user interface for use with an electronic device such as a computer, a speech generation device, or other device. A first example of a first program interface electronically generated in step 102 is shown in FIGS. 2 and 3, while a second example of a first program interface is shown in FIG. 4.

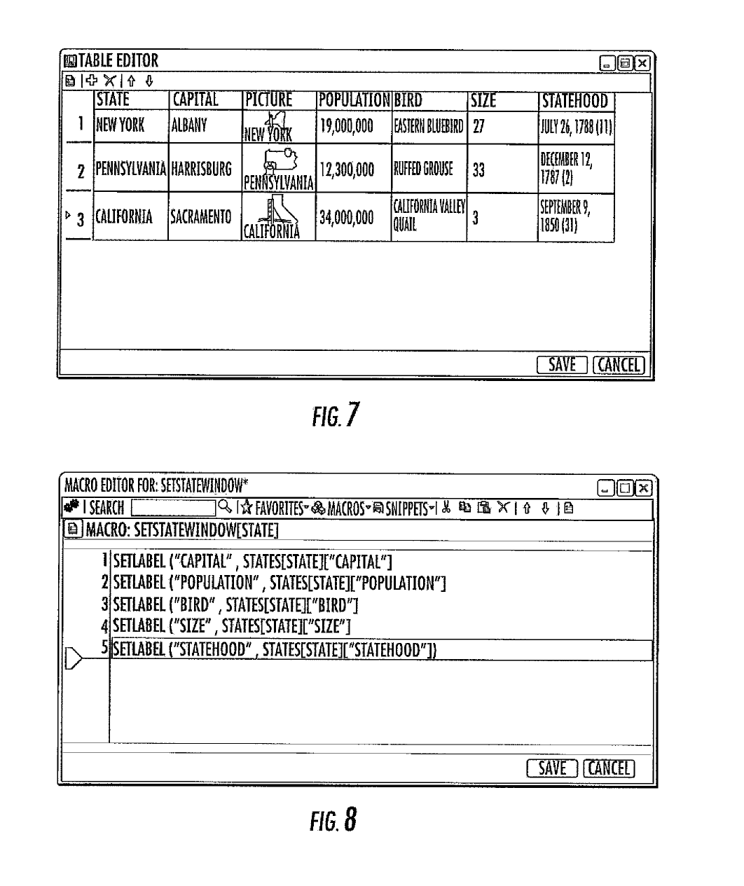

A second exemplary step in the method of FIG. 1 is to electronically generate a second program interface to provide a module for creating one or more shared data variables including content in the form of text, numbers, pictures, data tables, strings, numbers, Boolean variables, lists and the like. An example of a second program interface is shown in FIG. 7.

Step 106 involves electronically generating a third program interface for defining instructions to reference one or more shared data variables from an interactive content item. An example of such a third program interface is shown in FIG. 8. In step 108, instructions created via the third program interface are then electronically executed such that one or more elements in the interactive content item are populated with data from one or more of the shared data variables. By providing such multiple interfaces working together in a single application, it is possible to have different shared data variables used with the same interactive content item or different interactive content items using the same shared data variable.

It should be appreciated that the first, second and third program interfaces referenced herein all may be accessible from within a single application. In one example, one program interface may be accessible from another program interface. For example, the second and third program interfaces may be accessible by selecting display elements located on the first program interface. Different methods of accessing the different program interfaces within the integrated software application are contemplated and are within the spirit and scope of the presently disclosed technology.

The first program interface 200 shown in FIG. 2 may include one or more of the following elements configured for electronic display to a user. Such elements then may enable a user to interact with the first program interface 200 to create an interactive content item.

For example, first program interface 200 may include one or more of a title bar 201 and a menu bar 202. Additional basic display elements include a board workspace area 218 into which a user may create elements for an interactive content item, a page break indicator 220 for displaying where printed page breaks will occur, a board magnification indicator 221 for displaying the current view magnification levels in size by pixels, inches, centimeters, window percentage or other designation, and a dynamic help indicator 222 for displaying helpful information relative to the pointer position and action being performed within the board workspace area 218.

A variety of action items or selectable elements also may be provided within the first program interface 200. Examples include elements 203-217, now described in more detail. A symbol finder tool element 203 may actuate a control signal to trigger the display of a symbol finder window, for example as depicted as element 219. A pointer tool element 204 may enable the user to select buttons, text, graphics or other elements that are formed within the board workspace 218. A button tool element 205 may enable a user to create basic buttons (i.e., establish a button framework, including rectangular or other predetermined shape, location and size) for symbols and pictures. A freeform button tool element 206 may enable a user to create customized buttons, such as polygon-shaped buttons or other freeform outlines defining the shape, location and size of a freeform button. A button sprayer tool element 207 may enable a user to spray out button copies on the board workspace 218 to create a grid of buttons. A line tool element 208 may enable a user to draw lines on the board workspace 218. A text tool element 209 may enable a user to insert and edit text within the board workspace 218. A symbolate tool element 210 may enable a user to create a button in which symbols will appear automatically as text is typed based on an electronic mapping from the inputted text to a stored database of symbol options. A color tool element 211 may upon selection by a user display a color palette by which a user can set or change the color of buttons, text, graphics and backgrounds. A thickness tool element 212 may display a palette of line thickness options by which a user can select one of a variety of line thicknesses for a line, a button, or other outline. A corner tool element 213 may display a palette of corner shape options for buttons by which a user can select the shape of a button from a variety of preconfigured options such as ninety degree corners, slightly rounded corners, completely rounded corners (i.e., circular buttons), and other options. A shadow tool element 214 may toggle between non-shadow and 3-D shadow modes for a selected button or buttons. A zoom in element 215 and zoom out element 216 enable a user to respectively increase and decrease the size of the displayed elements within the board workspace 218. A movable button tool element 217 may create movable/destination button pairings.

Referring more particularly to symbol finder window element 219, FIG. 3 shows the various selectable items by which a user can select a graphical symbol (with or without an accompanying text label) to insert within the board workspace 218. For example, a user can input text in the search text field 305 in order to search for a symbol matching the inputted text. The symbol window 301 then provides a visual area in which the current symbol may be displayed to a user. A current symbol number element 302 may display the current and total number of symbols matching a given word or text provided as input by a user. Symbol name search option elements 303 enable a user to select whether to search for symbols based on the inputted text occurring at the beginning of a word, anywhere within a word or consisting of the whole word. Symbol finder window control elements 304 enable a user to minimize, maximize or close the symbol finder window element 219. Display thumbnail view element 306 enables a user to display thumbnails of matching symbols. Previous and Next Symbol Arrows 307 enable a user to step through the symbols or thumbnail screens of all or some selected or identified symbols. A select categories button element 308 enables a user to select one or more subsets of symbol categories within which to search. A symbol names button 309 enables a user to add an alternate name or category to a selected symbol. An alternate symbol name field 310 enables a user to replace a symbol name with a new name entered via the text box. An alternate symbol names list 311 displays a list of alternate names to select for a chosen symbol. A symbol finder settings element 312 enables a user to change various symbol finder settings. A selection marquee 313 enables a user to select a rectangular region within a given symbol to copy to the board workspace 218. A selection lasso 314 enables a user to select a freeform region within a given symbol to copy to the board workspace 218. Additional pop-up information about each symbol may be shown when a user positions the pointer on the symbol.

The exemplary interfaces shown in FIGS. 2 and 3 may provide a user with the opportunity to implement various actions described above and others. For example, in building an interactive content item (i.e., a board) and working with its appearance, a user may implement one or more of the following non-limiting actions: set a preferred paper and board size, create multi-page boards, resize a board's window, create a grid of buttons, adjust the button gap spacing, change the board or button background color, change the button border thickness, make an invisible button border, change the button border color, change the button shape, apply a dashed button border, apply a 3-D button shadow, clear a group of buttons, draw a freeform button, draw a polygonal freeform button, draw a button with straight and freeform sides, and/or create a regular polygon from a freeform button.

In working with the symbol finder, a user may implement such exemplary actions as search for symbols, search for symbols using categories, copy a symbol to a button, copy a symbol to another program, add a symbol to the symbol finder, use the alternate symbol names menu, make a one-time symbol name change, add or edit a symbol's alternate names, set the symbol finder font size, use different languages with the symbols, select a search category, assign categories to a symbol, create a new symbol category, enlarge the symbol finder window, select display options for symbol names, and/or select black and white or color symbol libraries.

In working with button text, a user may implement such exemplary actions as adding text with the text tool, reposition text fields, edit a symbol name with the text tool, change the text color, set the font, style and size, change the text justification, and/or change the text settings on multiple buttons.

In working with symbols on a board, a user may implement such actions as replacing a symbol on a button, adding an additional symbol to a button, resizing and repositioning a symbol, using a portion of a symbol (e.g., by selection using the marquee or lasso tools), and/or clearing symbols and text from selected buttons.

In working with symbolate buttons, a user may implement such actions as creating a symbolate button, editing symbolate text, changing the symbol for a word-symbol pairing, making new word-symbol pairs, changing the default word-symbol pairing, changing the text for a word-symbol pairing, changing the text position, adjusting the button border, changing the font and symbol size, setting the button's symbolate properties, and/or reading with the highlighting action.

In working with the board layout, a user may implement such actions as resizing buttons and graphics, resizing multiple buttons, swapping button content and appearance, shuffling buttons, and/or anchoring images and symbols on the background.

In working with the paint tools, a user may implement such actions as selecting various tools, including a transparency color tool, a pointer tool, a pencil tool, an eraser tool, a color tool, a thickness tool, a fill tool, a fill all tool, an invert tool, a flip horizontal tool, a flip vertical tool, and a rotate tool.

In adding new symbols or photos to the symbol finder, a user may implement such actions as importing saved photos or graphics, copying a new symbol from a button, naming and categorizing new symbols, deleting your custom symbols, organizing the symbol library, using drag and drop to add images, dragging and dropping images on the board background, dragging and dropping images from a web browser, dragging images into the symbol finder, and/or dragging multiple images into the symbol finder.

Options may be provided by which a user can designate or link actions to buttons such that user selection of a button in a created interactive content item triggers a linked action. Exemplary linked actions may include one or more of speaking a message (i.e., making the button speak the message entered by a user using a synthesized computer voice), typing a message (i.e., placing a message entered by the user into the message display), reading with highlighting (i.e., reading and highlighting the symbols and text on the face of a symbolate button), playing a recorded message (i.e., playing a message recorded by a user or a selected saved sound), changing a board to a new selected board or to a previously selected board, providing a text preview (i.e., displaying a text cue for the button's function when a pointer is placed over the button), providing a spoken preview (i.e., playing a synthesized voice cue for the button's function when a pointer is placed over the button), providing a recorded preview (i.e., playing a recorded cue for the button's function when a pointer is placed over the button), clearing the contents of the message display if a message display is present on the board, and/or providing a picture button (i.e., placing the symbol and/or graphic on the face of a button into the message display if a message display is present on the board). A user may implement such actions as making a button play a recorded message, giving a button a spoken preview, adding a preview display, editing a button's assigned actions, making a button speak, making a button play a saved sound, giving a button a recorded preview, and/or changing a button's text preview.

In linking boards together, a user may implement such actions as adding a button link to the main board, adding a button link to the previous board, and/or linking specific boards together.

In using a message display with text, a user may add a message display and set its appearance, make a button type a text message, add simple message display controls or actions, and change the message display's settings. In using a message display with pictures, a user may place a picture into the message display and/or implement uniform or non-uniform line spacing with pictures and/or text.

In working with movable buttons, a user may enable actions such as but not limited to showing the moveable button tool, creating moveable and destination buttons, editing actions for a moveable-destination button pair, setting a moveable button to “snap back,” setting a movable button to clone itself, centering a dropped moveable button, changing the button type, and/or implementing moveable buttons with a scanning access method.

A user may optionally play movies with a button, change voice and sound volume levels for audio actions, select and change voices, set private audible cues, change the pronunciation of words, print interactive boards, create passwords or greetings, display menu or title boards, save a board's action list and implement board or button usage counts.

A user may create or assign variables and values such that conditional actions can be taken upon variables attaining given values.

There are also a wide range of features and button actions that allow a user to create boards that can function as writing aids or talking word processors. Numerous typing boards may be supplied for selectable combination with other user-defined elements, such as buttons and the like. Alternatively, customized keyboards can be created with optional features such as but not limited to word prediction, abbreviation expansion, typing shortcuts to improve the speed and quality of a user's writing, text editing and cursor control buttons, file control buttons, message file boards, and basic access methods.

Referring now to FIG. 4, yet another example of a first program interface 400 is depicted. Many of the features accessible from the exemplary first program interface shown in FIGS. 2 and 3 are also available from such alternative first program interface 400. In general, first program interface 400 may include one or more of a title bar 401 and menu bar 402, as well as basic display elements including a project file selection window 403, a board workspace area 404, an object selection area 405, and an object properties modification area 406.

Many different types of objects are available to incorporate into an interactive content item created with the first program interface 400. These objects may be selected for placement within the board workspace area 404 by user selection of icons representing such objects, which icons are generally located in the object selection area 405 of first program interface 400. The different types of objects that may be selected include but are not limited to buttons 407, freeform buttons 408, symbols 409, labels 410, lines 411, videos 412, message windows 413, hot spots 414, freeform hot spots 415, word predictors 416, symbolate buttons 417, group buttons 418, group boxes 419, tab controls 420, check boxes 421, radio buttons 422 and multiple choice objects 423.

Once an object is selected and placed within the board workspace, various properties associated with such objects also may be modified by a user by selecting different menu items or other interface elements within the object properties modification area 406. For example, buttons 407, freeform buttons 408, hot spots 414, freeform hotspots 415, and word predictors all may be configured by defining selectable object properties including but not limited to: object type, label, symbol, layout, label font, style, shape, fill color and border color, status (e.g., disabled or not, hidden or visible, locked or not, selectable or not), name, actions associated with selecting the object, audio cue, dragging properties, and clipping properties.

Symbolate buttons 417 also may be configured by defining selectable object properties including those listed above as well as a status indicator to symbolate or not, and additional properties for implementing a symbolate function.

Group buttons 418 also may be configured by defining selectable object properties including those listed above (without label and symbol properties) and further including extra layout property for the content of the group buttons.

Symbol objects 409 may be configured by defining selectable object properties including but not limited to: label, layout, label font, status (disabled or not, hidden or not, locked or not), name, maintain aspect ratio or not, should selection be allowed on invisible parts of the symbol and dragging properties.

Label objects 410 may be configured by defining selectable object properties including but not limited to: font, justification, symbolate or not and properties for implementing symbolate, status (e.g., disabled or not, hidden or not, locked or not), name, indication of whether the label should be magnified automatically or not when entering text, indication of whether selection should be allowed on invisible parts of the label, and dragging properties for the label.

Video objects 412 may be configured by defining selectable object properties including but not limited to: name of the video to play, object name, audio cue, preview time, show preview (show the frame from the video at “preview time” in the rectangle), touch video (start or stop by touching the video), and repeat video (automatically repeat until signaled to stop).

Message Window objects 413 may be configured by defining selectable object properties including but not limited to: default font, symbolate or not and properties for implementing symbolate, message window style, fill color and border color, status (disabled or not, hidden or not, locked or not), message window name, actions upon object selection, audio cue, horizontal and vertical justification, scroll properties, identification of what device modes a user can be in and edit a message window, and option to implement spell checking or not.

Group box objects 419 may be configured by defining selectable object properties including but not limited to: layout, title, style, status (e.g., disabled or not, hidden or not, locked or not) and name.

Tab control objects 420 may be configured by defining selectable object properties including but not limited to: tab label, tab symbol, tab label font, style, status (e.g., disabled or not, hidden or not, locked or not), name, audio cue and tab width and height.

Check box objects 421 may be configured by defining selectable object properties including but not limited to label, justification, symbol for checked, symbol for unchecked, label font, style, shape, fill color and border color, status (disabled or not, hidden or not, locked or not), actions to run when selected, name, audio cue, size of the check box, start selected or not, show a frame around it or not.

Radio buttons 422 may be configured by defining selectable object properties including but not limited to label, justification, symbol for selected, symbol for unselected, label font, style, shape, fill color and border color, status (disabled or not, hidden or not, locked or not), actions to run when selected, name, audio cue, size of the radio button box, start selected or not, show a frame around it or not.

Multiple choice objects 423 may be configured by defining selectable object properties including but not limited to question, justification, answer information (label and symbol for each), font, style, shape, fill color and border color, status (disabled or not, hidden or not, locked or not), name, actions to execute when a selection is made, audio cue and layout.

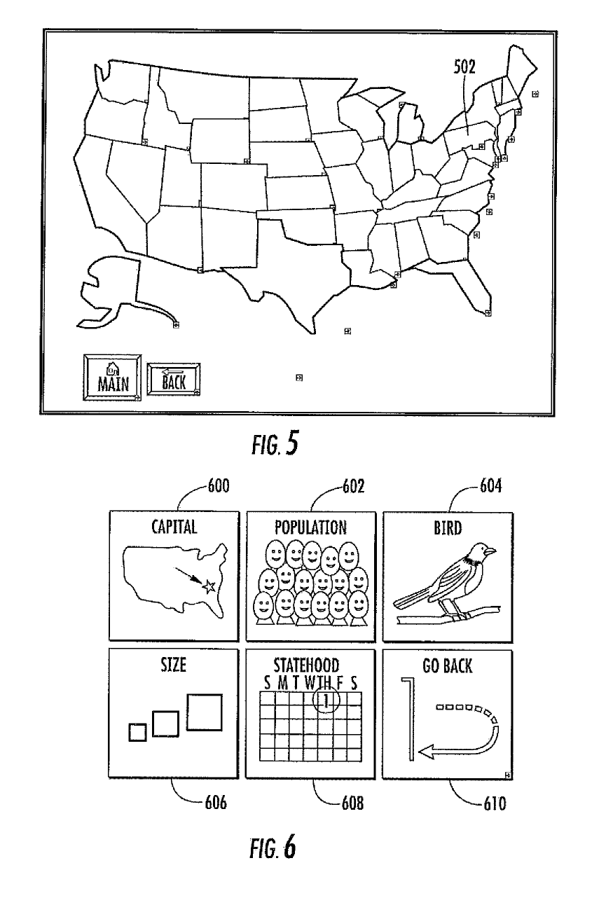

Referring now to FIGS. 5 and 6, examples of two different interactive content items (i.e., user interfaces or boards) created using the first program interface of FIGS. 2 and 3 or of FIG. 4 are shown. In FIG. 5, an interactive display is created corresponding to a map of the United States of America. Each state on the map is a different visual element, or button. Each such element could be configured with additional information such as a text identifier (i.e., label), or the like. In addition to varied visual representations associated with each state element on the map in FIG. 5, various actions are tied to each state. For example, in one embodiment a user placing the file pointer over the state of Pennsylvania (i.e., button 502) would trigger a message preview by which a voice synthesizer speaks the word “Pennsylvania.” In addition, user selection of the Pennsylvania button 502 could then be configured to speak information about Pennsylvania, show text about Pennsylvania, or even bring up another interactive content item (i.e., a new board) such as shown in FIG. 6.

Referring now to FIG. 6, assuming that the Pennsylvania element/button 502 was selected in the interactive content item of FIG. 5, a new interactive content item specifically applicable to Pennsylvania (similar embodiments of which may be linked to the other respective state buttons) may include such additional elements as a capital button 600, a population button 602, a bird button 604, a size button 606, a statehood button 608 and a return button 610 to go back to the map board shown in FIG. 5. The capital button 600 also may be linked with preview actions, message actions and/or other actions. For example, a message preview may be configured such that placement of a pointer over the capital button 600 causes an action for a device to speak the word “population.” Actual selection of the capital button 600 may trigger a message action that speaks the name of the capital of Pennsylvania, “Harrisburg” or a full sentence such as “The capital of Pennsylvania is Harrisburg.” The population button 602 may be linked to a message preview action to speak the word “population” and a message action to speak the following text: “The population of Pennsylvania is twelve million, three hundred thousand.” The bird button 604 may be linked to a message preview action to speak the words “state bird” and a message action to speak the following text: “The state bird of Pennsylvania is the ruffed grouse.” The size button 606 may be linked to a message preview action similar to the ones described above and a message action to speak the following text: “Pennsylvania is the thirty-third largest state.” The statehood button 608 also may be linked to a message preview action to speak “When it became a state” and/or a message action to speak the following text: “Pennsylvania became a state on Dec. 12, 1787. It is the second state.”

The type of information needed to implement the various actions tied to each of the buttons 600-610 shown in the interactive content item of FIG. 6 will obviously vary for each state. Instead of having to program these actions individually for each state and each button, it is possible to utilize the integrated interfaces of the presently disclosed technology.

FIG. 7 depicts an example of a second program interface that may be displayed upon execution of instructions stored in a computer-readable medium. In such example, such second program interface is provided to create and edit shared data variables that are populated with information such as text, numbers, values, etc. In one example, at least one display element is provided to a user via the second program interface such that a user can select a type of shared data variable (e.g., tables, strings, numbers, Boolean variables, lists, etc.) Additional optional parameters associated with a selected shared data variable type also may be defined, including, for example the number of data entries in the shared data variable. Based on the shared data variable type and additional optional parameters identifying the shared data variable, additional display features then may be provided via the second program interface such that data entries for the shared data variable can be populated by a user. Such data entries/elements can then be referenced by specifying their location in terms of one or more location parameters within the shared data variable (e.g., the row and column in a data table). In such fashion, the text or other data that appears in an interactive content item can make reference to and display the contents of shared data variables (e.g., data tables) loaded into an integrated application as presently disclosed and created using a program interface such as shown in FIG. 7.

Continuing with the interactive state example of FIGS. 4 and 5, a user may select a type for a shared data variable created using the second program interface shown in FIG. 7 to be a data table. Such data table may be defined with additional optional parameters specifying a size of fifty rows (corresponding to the fifty states in the United States) and seven columns (corresponding to the different categories of information made available to a user in the exemplary interactive content items of FIG. 5. A user can then either import or create a data table such as shown in FIG. 7, where data associated with each state is stored—e.g., state name, capital, picture, population, bird, size, statehood, etc. Each of these items in the data table can be referenced by one or more location parameters, such as the row and column numbers.

The integration of material created using the first program interface with shared data created or imported via the second program interface is made capable by a third program interface, an example of which is shown in FIG. 8. Such third program interface may include alphanumeric code representations and/or symbolic representations for a scripting language built into the third program interface. Such scripting language provides a mechanism to access and use data from the shared data variables created using the second program interface in the interactive content items created using the first program interface. For example, the scripting language could define access to the shared data variables and do things with the data such as put symbols or strings from the data variable into screen objects within an interactive content item, formulate questions to ask a user based on values from the table, etc.

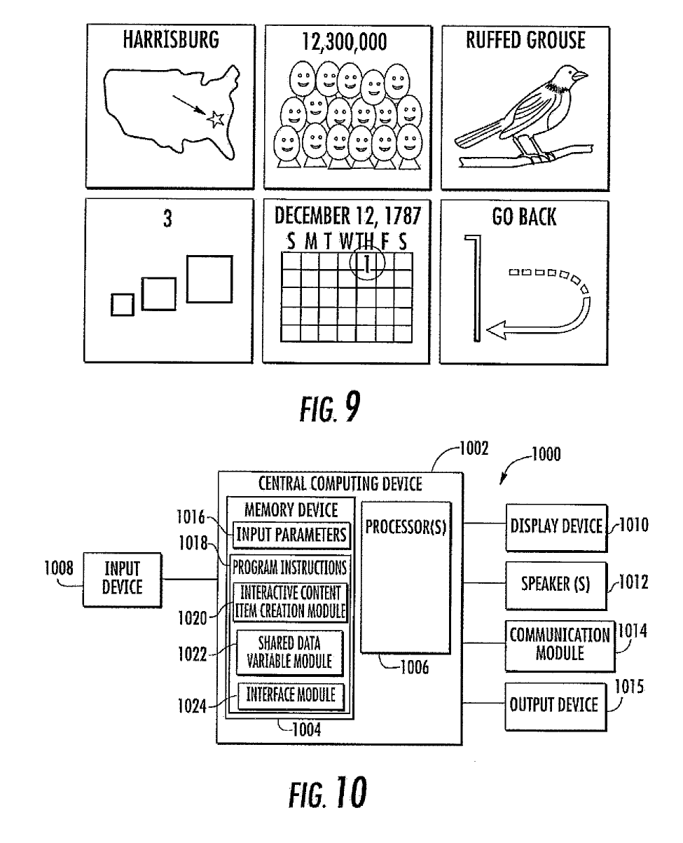

In the specific example of FIG. 8, the scripting language defines an interaction between the interactive content items of FIGS. 5 and 6 and the data provided in the data table of FIG. 7. In particular, the scripting language enables an automated program looping to integrate the data from the table shown in FIG. 7 to the data parameters defining each of the state buttons shown in the content items of FIGS. 5 and 6. Using the scripting language shown in FIG. 8, the data for each state (e.g., capital, population, bird, size, statehood from the data table of FIG. 7) may be used to label the various buttons 600-610. After execution of the particular code shown in FIG. 8, the content item originally shown in FIG. 6 could now look like the content item shown in FIG. 9, with buttons updated per the integration of data from the shared data variable of FIG. 7 into the interactive content item of FIG. 6.

The provision of the different interfaces and separate interactive content items and shared data variables, integrated in the fashion described above, provides several advantages. A single shared data variable can be used with different interactive content items. For example, the data table provided in FIG. 7 could be used to populate data for the interactive state items in FIGS. 5 and 6, but it could also be used for different interactive content items (e.g., a coloring book that has an outlined picture of each state and certain facts about each state, an educational content item that quizzes students about the capital of each state, and a wide variety of other activities). In addition, data in a shared data variable can be easily updated and then reused with an existing interactive content item. For example, when state populations are updated, such data could be changed in the data table of FIG. 7 and automatically linked to a variety of interactive content items using such data without having to manually recode and reprogram the data for each interactive content item and for each state within each content item.

Referring now to FIG. 10, exemplary hardware components for use in implementing the features and steps of the presently disclosed technology are depicted. FIG. 10 discloses an exemplary electronic device 1000, which may correspond to any general electronic device including such components as a computing device 1002, at least one input device 1008 and one or more output devices (e.g., display device 1010, speaker 1012, communication module 1014, and/or additional output device 1015.)

In more specific examples, electronic device 1000 may correspond to a stand-alone computer terminal such as a desktop computer, a laptop computer, a netbook computer, a palmtop computer, a speech generation device (SGD) or alternative and augmentative communication (AAC) device, such as but not limited to a device such as offered for sale by DynaVox Mayer-Johnson of Pittsburgh, Pa. including but not limited to the V, Vmax, Xpress, Tango, M³ and/or DynaWrite products, a mobile computing device, a handheld computer, a mobile phone, a cellular phone, a VoIP phone, a smart phone, a personal digital assistant (PDA), a BLACKBERRY™ device, a TREO™, an iPhone™, an iPod Touch™, a media player, a navigation device, an e-mail device, a game console or other portable electronic device, a combination of any two or more of the above or other electronic devices, or any other suitable component adapted with the features and functionality disclosed herein.

Referring more particularly to the exemplary hardware shown in FIG. 10, a computing device 1002 is provided to function as the central controller within the electronic device 1000 and may generally include such components as at least one memory/media element or database for storing data and software instructions as well as at least one processor. In the particular example of FIG. 10, one or more processor(s) 1006 and associated memory/media device 1004 are configured to perform a variety of computer-implemented functions (i.e., software-based data services). The one or more processor(s) 1006 within computing device 1002 may be configured for operation with any predetermined operating systems, such as but not limited to Windows XP, and thus is an open system that is capable of running any application that can be run on Windows XP. Other possible operating systems include BSD UNIX, Darwin (Mac OS X including specific implementations such as but not limited to “Cheetah,” “Leopard,” and “Snow Leopard” versions), Linux, SunOS (Solaris/OpenSolaris), and Windows NT (XP/Vista/7).

At least one memory/media device (e.g., device 1004 in FIG. 10) is dedicated to storing software and/or firmware in the form of computer-readable and executable instructions that will be implemented by the one or more processor(s) 1006. The same or other coupled memory/media devices are used to store data which will also be accessible by the processor(s) 1006 and which will be acted on per the software instructions stored in memory/media device 1004. Computing/processing device(s) 1006 may be adapted to operate as a special-purpose machine by executing the software instructions rendered in a computer-readable form stored in memory/media element 1004. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific integrated circuits.

The various memory/media devices of FIG. 10 may be provided as a single portion or multiple portions of one or more varieties of computer-readable media, such as but not limited to any combination of volatile memory (e.g., random access memory (RAM, such as DRAM, SRAM, etc.)) and nonvolatile memory (e.g., ROM, flash, hard drives, magnetic tapes, CD-ROM, DVD-ROM, etc.) or any other memory devices including diskettes, drives, other magnetic-based storage media, optical storage media and others. In some embodiments, at least one memory device corresponds to an electromechanical hard drive and/or or a solid state drive (e.g., a flash drive) that easily withstands shocks, for example that may occur if the electronic device 1000 is dropped. Although FIG. 10 shows a single memory device, the content stored within such device may actually be stored in multiple memory devices or multiple portions of memory. Any such possible variations and other variations of data storage will be appreciated by one of ordinary skill in the art.

In one particular embodiment of the present subject matter, memory/media device 1004 is configured to store input data received from a user. Such portion of memory is identified in FIG. 10 as the memory module 1016 configured to temporarily or permanently store input parameters. Input data may include information provided by a user through the one or more program interfaces available to a user through the subject applications, including items within an interactive content item created using the first program interface, data provided into the shared data variables created using the second program interface, and/or scripting created or modified using the third program interface. Such input data may be received from one or more integrated or peripheral input devices 1008 associated with electronic device 1000, including but not limited to a keyboard, joystick, switch, touch screen, microphone, eye tracker, camera, or other device.

Memory device 1004 also includes computer-executable program instructions that can be read and executed by processor(s) 1006 to act on the data stored in memory/media device 1004 to create new output data (e.g., display signals, audio signals, communication signals, control signals and the like) for temporary or permanent storage in memory, e.g., in memory/media device 1004. Such output data may be communicated to integrated and/or peripheral output devices, such as a monitor or other display device, or as control signals to still further components.

In the example of FIG. 10, program instructions 1018 stored within memory/media device 1004 can be considered as including at least three basic modules, each of which function together as part of an application implemented in accordance with the disclosed technology. A first such module of program instructions corresponds to an interactive content item creation module 1020. Execution of the computer-readable instructions embodied by module 1020 will cause the first program interface to be displayed to a user and will include the instructions required for a user to run, interact, change and provide inputs to such first program interface and related features and functionalities. A second module of program instructions corresponds to a shared data variable module 1022. Execution of the computer-readable instructions embodied by module 1022 will cause the second program interface to be displayed to a user and will include the instructions required for a user to run, interact, change and provide inputs to such second program interface and related features and functionalities. A third module of program instructions corresponds to an interface module 1024. Execution of the computer-readable instructions embodied by module 1024 will cause the third program interface to be displayed to a user and will include the instructions required for a user to run, interact, change and provide inputs to such third program interface.

Referring still to FIG. 10, various output modules also may be coupled to central computing device 1002 to assist with providing the desired functionality of the electronic device 1000. In one embodiment, such additional output modules include one or more of a display device 1010, a speaker 1012, a communication module 1014, and a peripheral output device 1015.

Display device 1010 may correspond to one or more substrates outfitted for providing images to a user. Display device 1010 may employ one or more of liquid crystal display (LCD) technology, light emitting polymer display (LPD) technology, light emitting diode (LED), organic light emitting diode (OLED) and/or transparent organic light emitting diode (TOLED) or some other display technology. In one exemplary embodiment, a display device includes an integrated touch screen to provide a touch-sensitive display that implements one or more of the above-referenced display technologies (e.g., LCD, LPD, LED, OLED, TOLED, etc.) or others. The touch sensitive display can be sensitive to haptic and/or tactile contact with a user (e.g., a capacitive touch screen, resistive touch screen, pressure-sensitive touch screen, etc.).

Speaker(s) 1012 may generally correspond to any compact high power audio output device. Speakers 1012 may function as an audible interface for the electronic device 1000 when computer processor(s) 1006 utilize text-to-speech functionality to implement a speech generation device. Speakers can be used to speak messages composed in a message window as well as to provide audio output for interfaced telephone calls, speaking e-mails, reading e-books, and other functions. As such, the speakers 1012 and related components enable the electronic device 1000 to function as a speech generation device, or particular special-purpose electronic device that permits a user to communicate with others by producing digitized or synthesized speech based on configured messages. Such messages may be preconfigured and/or selected and/or composed by a user within a message window provided as part of the speech generation device user interface.

One or more communication modules 1014 also may be provided to facilitate interfaced communication between the electronic device 1000 and other devices. For example, exemplary communication modules may correspond to antennas, Infrared (IR) transceivers, cellular phones, RF devices, wireless network adapters, or other elements. In some embodiments, communication module 1014 may be provided to enable access to a network, such as but not limited to a dial-in network, a local area network (LAN), wide area network (WAN), public switched telephone network (PSTN), the Internet, intranet or ethernet type networks, wireless networks including but not limited to BLUETOOTH, WI-FI (802.11b/g), MiFi and ZIGBEE wireless communication protocols, or others. The various functions provided by a communication module 1014 will enable the device 1000 to ultimately communicate information to others as spoken output, text message, phone call, e-mail or other outgoing communication.

The additional output device 1015 shown in FIG. 10 may correspond to a variety of integrated or peripheral devices. For example, output device 1015 may correspond to a microphone, a printer, a camera or other device. In one example, a camera may include an optical sensor, e.g., a charged coupled device (CCD) or a complementary metal-oxide semiconductor (CMOS) optical sensor, or other device can be utilized to facilitate camera functions, such as recording photographs and video clips, and as such may function as another input device.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of interfacing interactive content items and shared data variables in a computer-based application, comprising:
electronically generating a first program interface to provide a module for creating one or more interactive content items having one or more objects;
electronically generating a second program interface to provide a module for creating one or more shared data variables and for populating the shared data variables with data;
electronically generating a third program interface for defining computer-executable instructions to reference one or more of the shared data variables from the one or more interactive content items; and
electronically executing the computer-executable instructions defined by the third program interface to populate the one or more objects within the one or more interactive content items with data from the one or more shared data variables.

2. The method of claim 1, wherein the one or more objects within the one or more interactive content items created via the first program interface comprise one or more of a button, freeform button, line, text, symbol, label, video, message window, hot spot, freeform hot spot, symbolate button, word predictor, group button, group box, tab control, check box, radio button and multiple choice object.

3. The method of claim 1, wherein the one or more shared data variables created via the second program interface comprise one or more of text, numbers, pictures, tables, strings, numbers, Boolean variables and lists.

4. The method of claim 1, wherein at least one of said first, second and third program interfaces is accessible be selecting a display element located on one of the others of said first, second and third program interfaces.

5. The method of claim 1, wherein the one or more shared data variables created via the second program interface are defined in terms of location parameters for the data within the one or more shared data variables so that the executable instructions created via the third program interface can reference particular aspects of the one or more shared data variables based on the location parameters of the data.

6. The method of claim 1, wherein at least one of the one or more objects within the one or more interactive content items has an associated message action configured to provide audio output upon selection of the at least one object.

7. The method of claim 1, wherein the first program interface comprises a plurality of display elements including a board workspace area and a plurality of selectable elements for placing a variety of objects within the board workspace area.

8. A computer readable medium comprising computer readable and executable instructions configured to control a processing device to:
electronically generate a first program interface to provide a module for creating one or more interactive content items having one or more objects;
electronically generate a second program interface to provide a module for creating one or more shared data variables and for populating the shared data variables with data;
electronically generate a third program interface for defining computer-executable instructions to reference one or more of the shared data variables from the one or more interactive content items; and
electronically execute the computer-executable instructions defined by the third program interface to populate the one or more objects within the one or more interactive content items with data from the one or more shared data variables.

9. The computer readable medium of claim 8, wherein the one or more objects within the one or more interactive content items created via the first program interface comprise one or more of a button, freeform button, line, text, symbol, label, video, message window, hot spot, freeform hot spot, symbolate button, word predictor, group button, group box, tab control, check box, radio button and multiple choice object.

10. The computer readable medium of claim 8, wherein the one or more shared data variables created via the second program interface comprise one or more of text, numbers, pictures, tables, strings, numbers, Boolean variables and lists.

11. The computer readable medium of claim 8, wherein said computer readable and executable instructions are further configured to control a processing device to access at least one of the first, second and third program interfaces upon selection of a display element located on one of the others of said first, second and third program interfaces.

12. The computer readable medium of claim 8, wherein the one or more shared data variables created via the second program interface are defined in terms of location parameters for the data within the one or more shared data variables so that the executable instructions created via the third program interface can reference particular aspects of the one or more shared data variables based on the location parameters of the data.

13. The computer readable medium of claim 8, wherein at least one of the one or more objects within the one or more interactive content items has an associated message action configured to provide audio output upon selection of the at least one object.

14. The computer readable medium of claim 8, wherein the first program interface comprises a plurality of display elements including a board workspace area and a plurality of selectable elements for placing a variety of objects within the board workspace area.

15. An electronic device, comprising:
at least one electronic output device configured to display first, second and third program interfaces to a user;
at least one electronic input device configured to receive electronic input from a user selected relative to the first, second and third program interfaces, wherein the first program interface enables electronic creation of one or more interactive content items having one or more objects, wherein the second program interface enables electronic creation of one or more shared data variables, and wherein the third program interface enables electronic definition of computer-executable instructions to reference one or more of the shared data variables from the one or more interactive content items; and
a processing device configured to electronically execute the computer-executable instructions defined by the third program interface to populate the one or more objects within the one or more interactive content items with data from the one or more shared data variables.

16. The electronic device of claim 15, wherein said electronic device comprises a speech generation device that comprises at least one speaker for providing audio output.

17. The electronic device of claim 15, wherein said processing device is further configured to display as part of the first program interface a plurality of display elements including a board workspace area and a plurality of selectable display elements for placing a variety of objects within the board workspace area.

18. The electronic device of claim 17, wherein the plurality of selectable display elements within the first program interface comprise one or more of a button, freeform button, line, text, symbol, label, video, message window, hot spot, freeform hot spot, symbolate button, word predictor, group button, group box, tab control, check box, radio button and multiple choice object.

19. The electronic device of claim 15, wherein the one or more shared data variables created via the second program interface comprise one or more of text, numbers, pictures, tables, strings, numbers, Boolean variables and lists.

20. The electronic device of claim 15, wherein the one or more shared data variables created via the second program interface are defined in terms of location parameters for the data within the one or more shared data variables so that the executable instructions created via the third program interface can reference particular aspects of the one or more shared data variables based on the location parameters of the data.
